(19) United States
(12) Patent Application Publication
(10) Pub. No.: US 2012/0070700 A1
(43) Pub. Date: Mar. 22, 2012

(54) ELEMENT FOR REGULATING THE INTERNAL GAS PRESSURE IN LITHIUM-ION CELLS

(76) Inventors: Ingo KERKAMM, Stuttgart-Rohr (DE); Niko DORSCH, Leonberg (DE)

(21) Appl. No.: 13/231,483

(22) Filed: Sep. 13, 2011

(30) Foreign Application Priority Data
Sep. 21, 2010 (DE) 102010041131.0

(51) Int. Cl. H01M 10/42; H01M 2/00; H01M 2/02

(52) U.S. Cl. 429/7; 429/163; 429/164

(57) ABSTRACT

A lithium-ion cell, including a housing, a positive electrode, a negative electrode, and a separator situated between the positive electrode and the negative electrode, which is distinguished by an element for regulating the internal gas pressure, which does not permit discharge of gas from the lithium-ion cell.

### CROSS REFERENCE

The present application claims the benefit under 35 U.S.C. §119 of German Patent Application No. DE 102010041131.0, filed on Sep. 21, 2010, which is expressly incorporated herein by reference in its entirety.

### Field of the Invention

The present invention relates to lithium-ion cells, in particular lithium-ion cells which have an element for regulating the internal gas pressure.

### BACKGROUND INFORMATION

Lithium-ion storage batteries are storage batteries which function on the basis of lithium ions. Lithium-ion storage batteries are also referred to as lithium-ion batteries, Li-ion batteries, Li-ion secondary batteries, or lithium storage batteries. The term “storage battery” refers to a storage for electrical energy based on an electrochemical system. A storage battery may be constructed from one or more rechargeable secondary cells. Multiple secondary cells may be connected in series to increase the total voltage or in parallel to increase the capacity. A lithium-ion storage battery accordingly includes one lithium-ion cell or multiple lithium-ion cells. Lithium-ion cells are distinguished by high energy density and thermal stability. A further advantage of lithium-ion cells is that no capacity loss occurs, even in the event of frequent partial discharge. Lithium-ion cells therefore do not display the so-called memory effect.

A lithium-ion cell typically includes a positive electrode, a negative electrode, an electrolyte, a separator, and a housing. The positive electrode of a lithium-ion cell is made of a lithium metal oxide or a mixture of various lithium metal oxides. The lithium metal oxide or the lithium metal oxides for the positive electrode may be selected from the group which includes LiCoO₂, LiNiO₂, LiMn₂O₄, LiNiO₂, LiNi₁₋ₓCoₓO₂, LiNi_{0.85}Co_{0.1}Al_{0.05}O₂, LiNi_{0.33}Co_{0.33}Mn_{0.33}O₂, and LiFePO₄. The negative electrode of a lithium-ion cell is typically made of graphite, nanocrystalline, amorphous silicon, Li₄Ti₅O₁₂, or SnO₂.

The electrolyte of a lithium-ion cell may be made of a non-aqueous, aprotic solvent, in which lithium salts are dissolved. Examples of aprotic solvents are ethylene carbonate, propylene carbonate, γ-butyrolactone, dimethyl carbonate, diethyl carbonate, or 1,2-dimethoxy ethane. The lithium salts may be LiPF₆, LiBF₄, LiClO₄, LiAsF₆, or LiCF₃SO₃. In the lithium-ion storage batteries, which are also referred to as lithium polymer storage batteries, a polymer is used as the electrolyte carrier, for example, polyethylene oxide, polyphenylene plastic, polyvinylidene fluoride (PVF), or polyvinylidene fluoride hexafluoropropene (PVDF-HFP). For example, LiCF₃SO₃, Li_{1.3}Al_{0.3}Ti_{1.7}(PO₄)₃, LiTaO₃, SrTiO₃, LiTi₂(PO₄)₃.Li₃PO₄, LiCl, LiBr, or LiJ are used as the ion conductors.

The electrodes in the lithium-ion cell are separated by a separator. The separator is a component for physical separation and electrical insulation between the electrodes of opposing polarity. The separator is permeable to lithium ions, but it prevents a short-circuit between the electrodes. The separator is preferably made of a porous polypropylene/polyethylene film for acid electrolytes. For alkaline systems, the separator is preferably made of polypropylene/polyethylene nonwoven materials. Ceramic separators are also currently used.

During the charging procedure, the positively charged lithium ions travel through the electrolyte to the negative electrode, while the charging current delivers the electrons via the external circuit. The lithium ions form an intercalation compound with the material of the negative electrode. During discharge, the lithium ions travel back into the metal oxide and the electrons may flow via the external circuit to the positive electrode (now the cathode). A lithium-ion storage battery or a lithium-ion cell therefore generates the source voltage by displacing lithium ions. However, metallic lithium does not occur in any of the reactions which run in a lithium-ion cell.

Currently, there are three different types of lithium-ion cells which differ from one another: cylindrical lithium-ion cells, prismatic lithium-ion cells, and so-called pouch cells.

Cylindrical lithium-ion cells have an essentially circular cross section. Therefore, they have the form of a cylinder and may correspond in size, for example, to the standardized, widespread sizes for cylindrical round cells, for example, the 18650 cells. Cylindrical cells have a rigid housing, so that they may withstand mechanical stresses well. However, cylindrical cells may be stacked poorly and have a low ratio of surface area to volume, so that they are comparatively difficult to cool.

Prismatic lithium-ion cells typically have a rectangular, cuboid structure, both with respect to their cross section and also their longitudinal section. However, the housing of prismatic cells is not as rigid as that of round cells. In the pouch cells, the electrodes, the electrolyte, and the separator are welded into a film. In contrast to the prismatic lithium-ion cells, the pouch cells do not have a rigid housing. However, the pouch cells typically also have a rectangular basic shape. Prismatic cells and pouch cells may be stacked significantly better than round cells because of their angular shape and they have a ratio of surface area to volume which is more favorable for their cooling.

Lithium-ion cells for device batteries are typically produced in winding technology. The electrolyte compound is applied to the thin, sheet-like electrodes and the electrodes, which are laid one on top of another in strips and separated from one another by a somewhat wider separator band, are rolled up together to form a cylindrical (round cell) or a flat (prismatic cell) coil. This coil is pushed into a corresponding housing or a bag and the cells are subsequently hermetically sealed.

Currently, it has not been definitively established whether mechanical pressure must be exerted on prismatic lithium-ion cells or lithium-ion cells of the pouch type to allow for a long service life of the cells. Fundamentally, the stability of the electrolyte increases with increasing pressure, so that the decomposition of the electrolyte slows with increasing pressure. Exerting a mechanical pressure therefore at least does not appear to be disadvantageous. Notwithstanding this, a low contact pressure appears to be advantageous for the homogeneity of the layer thicknesses and the stability of the microstructures in the cell. Therefore, different lithium-ion storage batteries having prismatic cells or pouch cells are available on the market, in which a mechanical pressure is exerted on the cell(s).

The electrolyte of a lithium-ion cell typically decomposes during the service life of the cell, so that the internal gas pressure in the hermetically sealed lithium-ion cells rises over time even if they are used according to instructions. The increase of the internal gas pressure may be observed well in the case of pouch cells because of the yielding cell envelope. In the case of the more rigid round cells and prismatic cells, the increase of the internal gas pressure is not necessarily visible. However, at least in the case of prismatic cells, a change of the housing shape because of the increasing internal gas pressure may be detected.

In order to limit the internal gas pressure in lithium-ion cells, installing a pressure relief valve in the envelope of a lithium-ion cell has been proposed in the related art. For example, lithium-ion cells of the pouch type are described in U.S. Pat. No. 5,916,704 and Japanese Patent Application No. JP-09199099-A, in which a pressure relief valve is situated in the sheet-like envelope of the cell. In the lithium-ion cell described in Japanese Patent Application No. JP-09199099-A, which includes a cell coil in a bag-shaped envelope, the internal gas pressure is to be kept at 1.2 kg/cm² to 20 kg/cm². Suitable valves for a lithium-ion cell according to U.S. Pat. No. 5,916,704 are to open in the case of a pressure differential of approximately 9.5 millibar between the inside and the outside, for example.

A prismatic lithium-ion cell is described in the Korean Patent Application No. KR-2004022715-A, which has a deformable part as an opening for injecting electrolyte solution and an insulator, which may be deformed if the gas pressure in the cell exceeds an established limiting value.

### SUMMARY

An object of the present invention is to provide a lithium-ion cell, including a housing, a positive electrode, a negative electrode, and a separator situated between the positive electrode and the negative electrode, the lithium-ion cell being distinguished in that it has an element for regulating the internal gas pressure, which does not permit a discharge of gas from the lithium-ion cell.

The element for regulating the internal gas pressure is not a valve, using which the discharge of gas from the cell may be controlled, but rather a deformable element, preferably a reversibly deformable element, which is impermeable to gas, and which is situated in the cell or in the housing wall of the cell. The element for regulating the internal gas pressure may be provided in the form of a diaphragm and/or in the form of a hollow body.

The example lithium-ion cell according to the present invention may be a cylindrical lithium-ion cell or a prismatic lithium-ion cell. The lithium-ion cell according to the present invention also includes specific embodiments in which a lithium-ion cell of the pouch type is situated in a housing. These last-mentioned specific embodiments are understood as cylindrical or prismatic lithium-ion cells as defined in the present invention and as a function of the shape of the housing in which the pouch cell is situated.

The lithium-ion cells according to the present invention have a generally rigid or stiff housing. In one specific example embodiment, the lithium-ion cells of the present invention have a housing which hermetically encloses the cell. Hermetically enclosing the cell is understood as defined in the present invention to mean that the housing encloses the electrolyte in a way which is airtight or impermeable to gases. However, the lithium-ion cells according to the present invention preferably have a pressure relief valve, with the aid of which excessive gas pressure occurring in the event of overheating of the lithium-ion cell may be dissipated. The dissipation of the excessive pressure is performed with the aid of a pressure relief valve which opens in the event of a predetermined excessive pressure in the interior of the cell. In that the valve opens at a predetermined internal gas pressure, the gas under high pressure may escape from the interior of the housing. The pressure relief valve may close again if the pressure in the interior of the cell falls below a predetermined pressure. The gas pressure present in the interior of the cell is therefore not completely reduced to the gas pressure of the surroundings of the cell, but rather a predetermined internal gas pressure may be maintained.

In one specific embodiment of the lithium-ion cell according to the present invention, the element for regulating the internal gas pressure is a deformable hollow body, preferably a reversibly deformable hollow body. Deformable hollow body as defined in the present invention means that the hollow body or at least a part of the hollow body may be compressed by the internal gas pressure occurring within the scope of the normal aging process of a lithium-ion cell. Reversibly deformable means that the hollow body returns to its original form if the internal gas pressure in the cell decreases again and falls below a predetermined value, for example, the internal gas pressure has again reached the original value, as prevailed immediately after the manufacture of the lithium-ion cell.

The deformable hollow body may have an envelope made of plastic or a metal. The deformable hollow body may be filled using air, a gas, or a gas mixture. In a preferred specific embodiment, the deformable hollow body is filled using an inert gas. The inert gas may be selected from the group of gases which includes nitrogen, helium, argon, neon, xenon, krypton, and arbitrary mixtures of the above-mentioned gases. The hollow body may also be filled using a foam, however.

The pressure in the interior of the deformable hollow body is preferably as high as or somewhat higher than the gas pressure of the lithium-ion cell, which encloses the hollow body, immediately after its manufacture.

In a particularly preferred specific embodiment, the deformable hollow body is designed as a floating bladder made of a plastic, which is filled using an inert gas. In another specific embodiment, the deformable hollow body is designed as a closed metal container, i.e., a type of can, which may also be unfilled, i.e., filled using a vacuum.

The deformable hollow body is situated in the interior of the lithium-ion cell. In a preferred embodiment configuration, the deformable hollow body is situated in the lithium-ion cell between the cell coil and the inner wall of the housing, at which the contacts exit for the electrical connection of the diverters of the electrodes to the circuit. In another preferred specific embodiment, the deformable hollow body is situated between the cell coil and the inner wall of the housing, which is opposite to the inner wall at which the contacts exit for the electrical connection of the diverters of the electrodes to the circuit.

In certain specific embodiments of the lithium-ion cell according to the present invention, the element for regulating the internal gas pressure is designed as a flexible or movable diaphragm. In these specific embodiments, the diaphragm may be provided as part of the housing of the cell or as part of the envelope of the deformable hollow body and may represent the deformable part. The present invention includes specific embodiments of lithium-ion cells in which the housing has a diaphragm as an element for regulating the internal gas pressure. However, the present invention also includes specific embodiments of lithium-ion cells in which the envelope of the deformable hollow body has a diaphragm.

The diaphragm is impermeable to the electrolyte, to any arbitrary component of the electrolyte, and to gases. In a preferred specific embodiment, the diaphragm is an integral component of the housing or the envelope of the deformable hollow body in that the housing or the envelope is made sufficiently thin-walled in one area in such a way that this area may function as a flexible diaphragm. The diaphragm is accordingly formed by the thin-walled area on one side of the housing or the deformable hollow body.

In the specific embodiments in which the housing of the lithium-ion cell has a diaphragm, the diaphragm is preferably situated on the side opposite to the diverters or the housing wall is made sufficiently thin-walled in one area of this side in such a way that the housing wall functions as a movable diaphragm. The diaphragm or the housing wall in this area preferably has a thickness of 0.1 mm to 1 mm, particularly preferably a thickness of 0.3 mm to 0.5 mm. In other specific embodiments, the housing may have an opening, which is closed using a diaphragm, on the side opposite to the diverters. In these specific embodiments, the diaphragm is connected gastight to the housing as a separate component. This means that no gas may exit from the interior of the lithium-ion cell at the connection between diaphragm and housing.

In the specific embodiments in which the deformable hollow body includes a diaphragm and the envelope of the deformable hollow body has an opening, which is closed using the diaphragm, on one of its sides, the diaphragm is also connected gastight to the envelope of the hollow body, so that no gas may enter or exit the hollow body.

The housing of the lithium-ion cell, the envelope of the deformable hollow body, and/or the diaphragm may be made of a metal, a plastic material, or a composite material. The material from which the housing of the lithium-ion cell, the envelope of the deformable hollow body, and/or the diaphragm are made is corrosion resistant with respect to the components of the electrolyte and the products which may arise during the chemical reactions running in the electrolyte. Aluminum is preferably used as the metal for the housing of the lithium-ion cell, for the envelope of the deformable hollow body, and/or for the diaphragm. Alternatively thereto, a composite film made of polyamide as the outer layer, aluminum as a diffusion barrier, and polyethylene or polypropylene as the inner layer of the composite film may be used.

### BRIEF DESCRIPTION OF THE DRAWINGS

Advantageous example embodiments of the objects of the present invention are illustrated in the figures and explained in detail below. It is to be considered that the figures have only descriptive character and are not intended to restrict the present invention in any way.

FIG. 1 shows a schematic cross section of a first specific embodiment of a lithium-ion cell according to the present invention.

FIG. 2A shows a schematic cross section of a second specific embodiment of a lithium-ion cell according to the present invention.

FIG. 2B shows another schematic cross section of the second specific embodiment of a lithium-ion cell according to the present invention.

### DETAILED DESCRIPTION OF EXAMPLE EMBODIMENTS

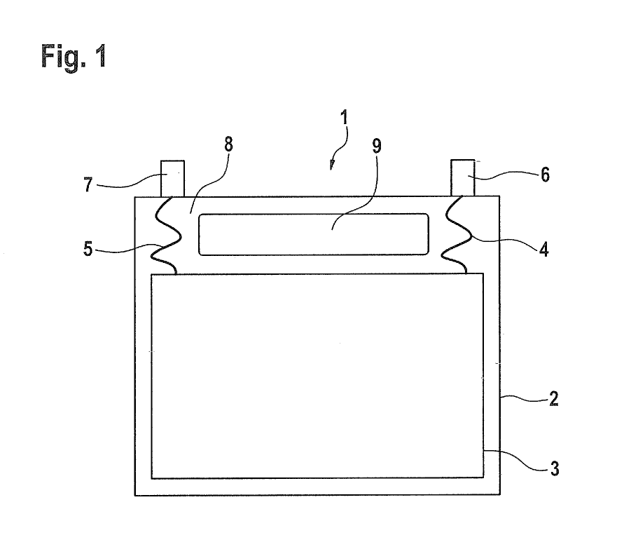

FIG. 1 shows a prismatic lithium-ion cell 1 which includes a housing 2, in which a cell coil 3 is located. Cell coil 3 includes an electrolyte, a positive electrode, and a negative electrode, which are separated from one another by a separator. The positive electrode is connected to positive pole 6 of cell 1 via diverter 4, which conducts electrical current. The negative electrode is connected to negative pole 7 of cell 1 via diverter 5, which conducts electrical current.

Lithium-ion cell 1 includes a deformable hollow body 9, which is situated in the interior of housing 2 between cell coil 3 and the wall of housing 2, which has positive pole 6 and negative pole 7.

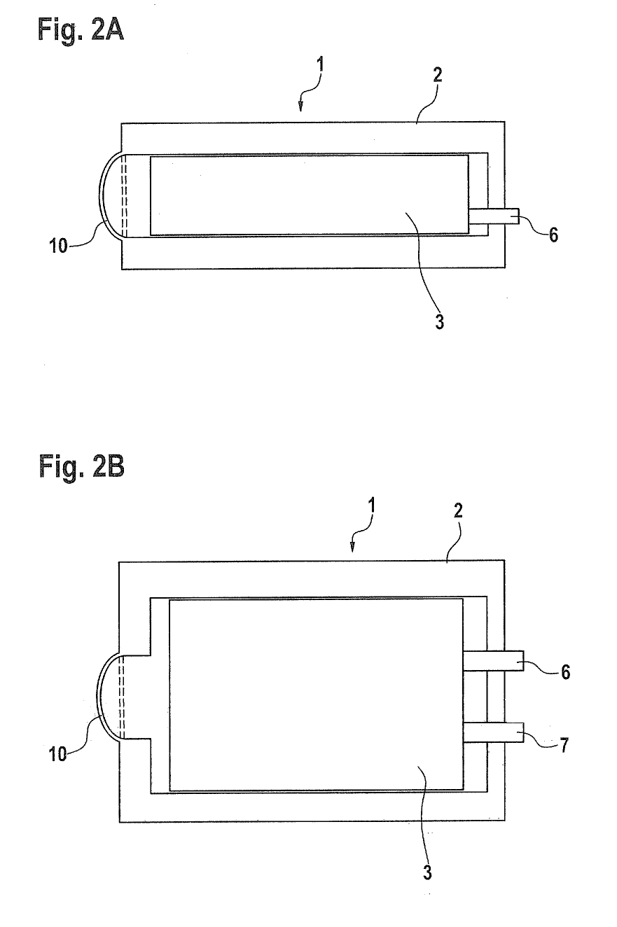

FIGS. 2A and 2B show another specific example embodiment of a prismatic lithium-ion cell according to the present invention in different cross-sectional views. Cell 1 includes a housing 2 and a cell coil 3. Cell coil 3 includes an electrolyte, a positive electrode, and a negative electrode, which are separated from one another by a separator. The positive electrode of cell coil 3 is electrically conductively connected to positive pole 6 of cell 1. The negative electrode of cell coil 3 is electrically conductively connected to negative pole 7 of cell 1.

Housing 2 of cell 1 has a movable diaphragm 10. Diaphragm 10 closes an opening in housing 2 of cell 1, which is situated in the wall of housing 2 opposite to the wall having poles 6, 7. Diaphragm 10 may be pressed outward by the increasing internal gas pressure in the interior of cell 1, so that the originally flat diaphragm (indicated by the dashed line) has a bulge.

What is claimed is:

1. A lithium-ion cell, comprising:
a housing;
a positive electrode;
a negative electrode;
a separator situated between the positive electrode and the negative electrode; and
an element for regulating an internal gas pressure in the housing which does not permit discharge of gas from the lithium-ion cell.

2. The lithium-ion cell as recited in claim 1, wherein the element for regulating the internal gas pressure is a deformable element which is impermeable to gas.

3. The lithium-ion cell as recited in claim 2, wherein the deformable element is a reversibly deformable element situated in one of the cell or a wall of the housing of the cell.

4. The lithium-ion cell as recited in claim 1, wherein the element for regulating the internal gas pressure is at least one of a diaphragm and a hollow body.

5. The lithium-ion cell as recited in claim 1, the cell is one of a cylindrical cell or a prismatic cell.

6. The lithium-ion cell as recited in claim 1, wherein the element for regulating the internal gas pressure is a reversibly deformable hollow body.

7. The lithium-ion cell as recited in claim 6, wherein the reversibly deformable hollow body is filled using one of air, a gas, or a foam.

8. The lithium-ion cell as recited in claim 6, wherein the reversibly deformable hollow body is filled using a gas selected from a group which includes at least one of nitrogen, helium, argon, neon, xenon, and krypton.

9. The lithium-ion cell as recited in claim 6, wherein the reversibly deformable hollow body is situated in an interior of the housing, between a cell coil and a wall of the housing, at which contacts exit for electrically connecting diverters of the positive and negative electrodes to a circuit, or between the cell coil and a wall of the housing which is opposite to the wall at which the contacts exit for electrically connecting the diverters of the positive and negative electrodes to the circuit.

10. The lithium-ion cell as recited in claim 1, wherein the element for regulating the internal gas pressure is a flexible diaphragm.

11. The lithium-ion cell as recited in claim 1, wherein the housing of the cell has a flexible diaphragm as the element for regulating the internal gas pressure.

12. The lithium-ion cell as recited in claim 6, wherein the deformable hollow body has a flexible diaphragm as the element for regulating the internal gas pressure.

13. The lithium-ion cell as recited in claim 12, wherein the diaphragm is formed by a thin-walled area of a wall on a side of the housing or of the deformable hollow body.
